(19) United States
(12) Patent Application Publication
(10) Pub. No.: US 2012/0181885 A1
(43) Pub. Date: Jul. 19, 2012

(54) SPINDLE MOTOR

(75) Inventors: Ho Jun Yoo, Gyunggi-do (KR); Yun Yeong Park, Gyunggi-do (KR); Young Sun Yoo, Gyunggi-do (KR)

(73) Assignee: SAMSUNG ELECTRO-MECHANICS CO., LTD., Gyunggi-do (KR)

(21) Appl. No.: 13/045,945

(22) Filed: Mar. 11, 2011

(30) Foreign Application Priority Data
Jan. 17, 2011 (KR) 1020110004571

(51) Int. Cl. H02K 11/00

(52) U.S. Cl. 310/71

(57) ABSTRACT

Disclosed herein is a spindle motor including: a rotor including a rotational axis and a magnet; and a stator including a bearing supporting the rotational axis and an armature corresponding to the magnet; wherein the rotor rotates by electromagnetic force between the magnet and the armature, the stator includes a printed circuit connected to the armature and having a hole for both set assembling and grounding formed therein; and a base plate having the printed circuit board coupled to an upper surface thereof so as to be stacked thereon and having a hole for both set assembling and grounding formed therein, the hole for both set assembling and grounding corresponding to the hole for both set assembling and grounding of the printed circuit board, and the hole for both set assembling and grounding of the printed circuit board and the hole for both set assembling and grounding of the base plate are fixed and grounded to a set.

### CROSS REFERENCE TO RELATED APPLICATION

This application claims the benefit of Korean Patent Application No. 10-2011-0004571, filed on Jan. 17, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor rotatably maintains a rotational axis, while maintaining a predetermined contact section between a bearing and the rotational axis, thereby making it possible to maintain rotational characteristics. Therefore, the spindle motor has been widely used as a driving unit of a recording medium requiring high speed rotation, such as a hard disk drive, an optical disk drive, etc.

However, a spindle motor for an optical disk according to the prior art has separate ground holes formed in a printed circuit board and a base plate coupled to the printed circuit board for grounding, and is coupled to a set through the ground holes, which causes a working process to be complicated and productivity to be deteriorated.

Hereinafter, problems of the spindle motor according to the prior art will be described in detail with reference to FIG. 1. FIG. 1 is a plan view schematically showing a spindle motor according to the prior art. As shown in FIG. 1, the spindle motor 100 is configured of a rotor including a rotational axis and a magnet, and a stator including a bearing supporting the rotational axis and an armature corresponding to the magnet. In this configuration, the rotor rotates by electromagnetic force between the magnet and the armature and the stator includes a printed circuit board 110 and a base plate 120.

The printed circuit board 110 has a ground hole 11 formed therein, and the base plate 120 has a ground hole (not shown) corresponding to the ground hole 111 of the printed circuit board and a plurality of set fixing holes 121 formed therein.

Then, the spindle motor is inserted into a set (not shown). The ground hole 111 of the printed circuit board 110 and the base plate 120 are fixed and grounded to the set through a ground pin (not shown), and are fixed to the set through fixing pins and the plurality of set fixing holes 121, such that the spindle motor is fixedly coupled to the set.

As a result, the printed circuit board and the base plate of the spindle motor have a complicated technical configuration, such that a degree of freedom in design and the reliability of a process are deteriorated. In addition, the spindle motor is coupled to the set in an overturn state during coupling to the set and is fixedly coupled to the set through the set fixing holes, such that the productivity is deteriorated.

### SUMMARY OF THE INVENTION

The present invention has been made in an effort to provide a spindle motor capable of being grounded and fixedly coupled to a set by forming a hole for both set assembling and grounding in a printed circuit board, forming a hole for both set assembling and grounding corresponding to the hole for both set assembling and grounding of the printed circuit board in a base plate, and fixing the printed circuit board and the base plate to the set through the hole for both set assembling and grounding of the printed circuit board and the hole for both set assembling and grounding of the base plate.

Further, the present invention has been made in effort to provide a spindle motor capable of being grounded and fixed to a set by a ground screw, a fixing screw, and the like, on an upper portion thereof during fixing to the set by allowing the spindle motor to have a low height.

According to a first preferred embodiment of the present invention, there is provided a spindle motor including: a rotor including a rotational axis and a magnet; and a stator including a bearing supporting the rotational axis and an armature corresponding to the magnet, wherein the rotor rotates by electromagnetic force between the magnet and the armature, the stator includes a printed circuit board connected to the armature and having a hole for both set assembling and grounding formed therein; and a base plate having the printed circuit board coupled to an upper surface thereof so as to be stacked thereon and having a hole for both set assembling and grounding formed therein, the hole for both set assembling and grounding corresponding to the hole for both set assembling and grounding of the printed circuit board, and the hole for both of set assembling and grounding of the printed circuit board and the hole for both set assembling and grounding of the base plate are fixed and grounded to a set.

The base plate may further include set assembling holes formed therein. In addition, the set assembling holes may be formed on each of both sides based on the hole for both set assembling and grounding.

The base plate may further include a circular protrusion formed in order to correct verticality during coupling to the set, and the circular protrusion is formed on a surface opposite to one surface of the base plate to which the printed circuit board is coupled.

Inner portions of the holes for both set assembling and grounding may be taped and have a tape screw inserted thereinto and coupled thereto.

The base plate may be inserted into the set, the hole for both set assembling and grounding of the printed circuit board and the hole for both set assembling and grounding of the base plate may be sequentially fixed to the set through a fixing screw, such that the spindle motor is fixed and grounded to the set.

The stator may further include: the bearing rotatably supporting the rotational axis; a stopper preventing separation of the rotational axis; a support supporting the stopper and the rotational axis; and a bearing holder receiving the bearing and fixing and supporting the bearing.

The rotor may further include: a clamping unit connected to an upper end of the rotational axis; and a rotor case connected to the rotational axis and having the magnet mounted in an inner peripheral surface thereof, the magnet corresponding to the armature.

The spindle motor may have a height of 5.4 to 6 mm, the set having the spindle motor mounted thereon may have a height of 9.5 to 12.7 mm, the spindle motor may be inserted into and fixed to the set, the hole for both set assembling and grounding of the printed circuit board and the hole for both set assembling and grounding of the base plate may be sequentially fixed and grounded to the set.

### BRIEF DESCRIPTION OF THE DRAWINGS

FIG. 1 is a plan view schematically showing a spindle motor according to the prior art;

FIG. 2 is a plan view schematically showing a spindle motor according to a preferred embodiment of the present invention;

FIG. 3 is a plan view schematically showing a printed circuit board and a base plate in the spindle motor shown in FIG. 2; and

FIG. 4 is a rear view schematically showing the printed circuit board and base plate shown in FIG. 3.

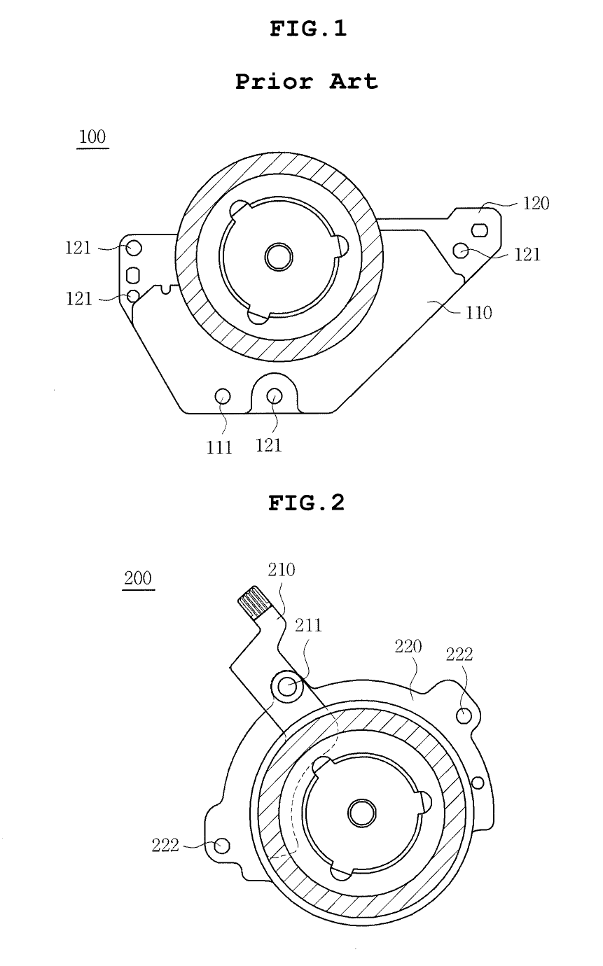

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

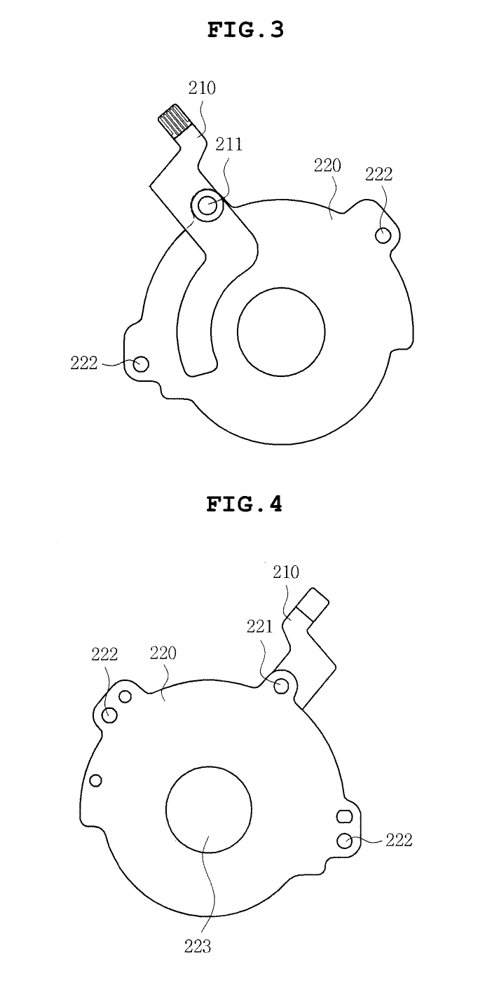

FIG. 2 is a plan view schematically showing a spindle motor according to a preferred embodiment of the present invention; and FIG. 3 is a plan view schematically showing a printed circuit board and a base plate in the spindle motor shown in FIG. 2 A spindle motor according to a preferred embodiment of the present invention is configured of a rotor including a rotational axis and a magnet, and a stator including a bearing supporting the rotational axis and an armature corresponding to the magnet. In this configuration, the rotor rotates by electromagnetic force between the magnet and the armature and the stator includes a printed circuit board 210 and a base plate 220, as shown in FIG. 2.

In addition, the printed circuit board 210 is connected to the armature, and has a hole 221 for both set assembling and grounding formed therein.

Further, the base plate 220 has a hole 221 for both set assembling and grounding and set assembling holes 222 formed therein. The hole 221 for both set assembling and grounding corresponds to the hole 211 for both set assembling and grounding of the printed circuit board 210, and the set assembling hole 222 is to fix and couple the spindle motor to a set. In addition, the set assembling holes 222 are preferably formed on each of both sides based on the hole 221 for both set assembling and grounding in order to obtain a stable structure.

In addition, the spindle motor according to a preferred embodiment of the present invention may be implemented so that inner portions of the holes 211 and 221 for both set assembling and grounding are taped and have a tape screw inserted thereinto and coupled thereto in order to maintain verticality during assembling of the spindle motor and the set.

FIG. 4 is a rear view schematically showing the printed circuit board and base plate shown in FIG. 3. As shown in FIG. 4, in the spindle motor 200 according to the preferred embodiment of the present invention, the base plate 220 includes a circular protrusion 223 formed in order to correct the verticality during coupling to the set. More specifically, the circuit protrusion 223 is formed on a surface opposite to one surface of the base plate to which the printed circuit board 210 is coupled.

In addition, the stator of the spindle motor according to the preferred embodiment of the present invention further includes the bearing rotatably supporting the rotational axis, a stopper preventing separation of the rotational axis, a support supporting the stopper and the rotational axis, and a bearing holder receiving the bearing and fixing and supporting the bearing.

Further, the rotor of the spindle motor according to the preferred embodiment of the present invention further includes a clamping unit connected to an upper end of the rotational axis and a rotor case connected to the rotational axis and having the magnet mounted in an inner peripheral surface thereof, the magnet corresponding to the armature.

In addition, the spindle motor according to the preferred embodiment of the present invention has a height of 5.4 to 6 mm, the set having the spindle motor mounted thereon has a height of 9.5 to 12.7 mm, the spindle motor is inserted into and fixed to the set, the hole for both set assembling and grounding of the printed circuit board and the hole for both set assembling and grounding of the base plate are sequentially fixed and grounded to the set.

As described above, the spindle motor according to the preferred embodiment of the present invention is inserted into the set, the hole for both set assembling and grounding of the printed circuit board and the hole for both set assembling and grounding of the base plate are sequentially fixed to the set through the fixing screw, such that the spindle motor is fixed and grounded to the set, thereby making it possible to increase stability of the spindle motor, reduce production cost thereof, and efficiently implement the spindle motor.

As described above, according to the preferred embodiment of the present invention, the hole for both set assembling and grounding is formed in the printed circuit board, the hole for both set assembling and grounding corresponding to the hole for both set assembling and grounding of the printed circuit board is formed in the base plate, and the printed circuit board and the base plate is fixed to the set through the hole for both set assembling and grounding of the printed circuit board and the hole for both set assembling and grounding of the base plate, thereby making it possible to allow the spindle motor to be grounded and fixedly coupled to the set. In addition, the spindle motor has a low height, thereby making it possible to allow the spindle motor to be grounded and fixed to the set by the ground screw, the fixing screw, and the like, on the upper portion thereof during fixing to the set.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A spindle motor comprising:
a rotor including a rotational axis and a magnet; and
a stator including a bearing supporting the rotational axis and an armature corresponding to the magnet,
wherein the rotor rotates by electromagnetic force between the magnet and the armature,
the stator includes a printed circuit board connected to the armature and having a hole for both set assembling and grounding formed therein; and a base plate having the printed circuit board coupled to an upper surface thereof so as to be stacked thereon and having a hole for both set assembling and grounding formed therein, the hole for both set assembling and grounding corresponding to the hole for both set assembling and grounding of the printed circuit board, and
the hole for both set assembling and grounding of the printed circuit board and the hole for both set assembling and grounding of the base plate are fixed and grounded to a set.

2. The spindle motor as set forth in claim 1, wherein the base plate further includes set assembling holes formed therein.

3. The spindle motor as set forth in claim 2, wherein the set assembling holes of the base plate are formed on each of both sides based on the hole for both set assembling and grounding.

4. The spindle motor as set forth in claim 1, wherein the base plate further includes a circular protrusion formed in order to correct verticality during coupling to the set, and the circular protrusion is formed on a surface opposite to one surface of the base plate to which the printed circuit board is coupled.

5. The spindle motor as set forth in claim 1, wherein inner portions of the holes for both set assembling and grounding are taped and have a tape screw inserted thereinto and coupled thereto.

6. The spindle motor as set forth in claim 1, wherein the base plate is inserted into the set, the hole for both set assembling and grounding of the printed circuit board and the hole for both set assembling and grounding of the base plate are sequentially fixed to the set through a fixing screw, such that the spindle motor is fixed and grounded to the set.

7. The spindle motor as set forth in claim 1, wherein the stator further includes:
the bearing rotatably supporting the rotational axis;
a stopper preventing separation of the rotational axis;
a support supporting the stopper and the rotational axis; and
a bearing holder receiving the bearing and fixing and supporting the bearing.

8. The spindle motor as set forth in claim 1, wherein the rotor further includes:
a clamping unit connected to an upper end of the rotational axis; and
a rotor case connected to the rotational axis and having the magnet mounted in an inner peripheral surface thereof, the magnet corresponding to the armature.

9. The spindle motor as set forth in claim 1, wherein the spindle motor has a height of 5.4 to 6 mm, the set having the spindle motor mounted thereon has a height of 9.5 to 12.7 mm, the spindle motor is inserted into and fixed to the set, the hole for both set assembling and grounding of the printed circuit board and the hole for both set assembling and grounding of the base plate are sequentially fixed and grounded to the set.
